(19) United States
(12) Patent Application Publication
(10) Pub. No.: US 2005/0199288 A1
(43) Pub. Date: Sep. 15, 2005

(54) Venturi valve modifications

(76) Inventor: Jean H. Scholten, Roswell, GA (US)

Correspondence Address: JAMES KUAN/TRIATEK, Inc., 2976 PACIFIC DR., NORCROSS, GA, 30071, US

(21) Appl. No.: 10/796,040

(22) Filed: Mar. 10, 2004

(51) Int. Cl. F16K 17/36

(52) U.S. Cl. 137/517

(57) ABSTRACT

Energy saving and efficiency structural improvements to venturi valve airflow control device that provides constant-velocity hood intake at all positions of hood access-opening for extended product life through the insertion of a “shock absorbing” device ring that maximizes the efficiency of the floating cone in the venturi valve.

This invention relates generally to air handling systems and particularly to the use of venturi valve exhaust and supply airflow devices.

Principal objects of the invention are to provide longer lasting, more efficient and stable venturi valve devices for increased energy and cost savings to laboratory and other facility owners through the structural improvements of the valves referenced herein.

As the development of laboratories for research proliferated during the mid-20^{th} century, concerns were raised for the health and well being of its occupants. Eventually, owners and facility managers realized a specific need to evacuate toxic fumes and carcinogens from the atmosphere to protect their employees and laboratory users.

Around the 1940s, in response to growing concerns for the safety of research and laboratory personnel, fume hood systems were developed to exhaust harmful air out of the laboratories. These fume hood systems evolved to provide laboratory safety to laboratory users and occupants by exhausting toxic fumes and carcinogenic materials out of the laboratory into the open air. A previous fume hood system ostensibly designed to provide uniform flow was seen in U.S. Pat. No. 2,715,359. That patent disclosed a bypass system in which full flow was always exhausted, the flow through the hood working-space tapping the total flow in proportion to access area opened at the hood access. While these constant volume approaches were effective at providing safety to users in the laboratory, as energy savings became important particularly in the 1970s, end users sought for a way to save energy. Thus, in most cases this system proved to be too expensive for end users as exhaust fans were often run at maximum capacity to meet the needs for air through the fume hoods.

The next step was the development of two state volume control systems during the 1970s. To combat the high cost of exhausted air, typically a room level light sensor, light-switch or other trigger device was used to setback the amount of air being exhausted when the lab was unoccupied. In this way, by reducing airflow when laboratories were unoccupied, exhaust fans did not need to run at full throttle, end users and facility managers were able to achieve tremendous cost savings in their laboratories without sacrificing safety. However, as energy costs skyrocketed during these and even more recent periods, end users continued to seek ways to decrease their energy requirements. This desire led to the advent of variable air volume systems during the 1980s.

Variable air volume systems provided the benefit of reducing airflow, and thus energy requirements, not only when laboratories were unoccupied by being able to reduce energy requirements when laboratories were occupied. These systems achieved energy savings by targeting fume hoods at the individual level so that energy requirements at each fume hood could be reduced depending on the sash opening. Based on the premise that sash openings that were decreased would need less air to maintain safe airflows, variable air volume systems utilized either airflow sensors or sash sensors to determine the amount of air needed at any fume hood. By measuring the sash opening and/or the airflow into the hood, these systems minimized the total amount of airflow (i.e. CFM) needed in any particular laboratory because sashes that were closed and/or whose openings were minimized needed this air. Furthermore, this advance also affected the design of laboratories. Based upon the premise that not all of the fume hoods in a laboratory would be in use all the time with all sashes raised at their full open position, designers could then design laboratories with fans with lesser CFM capacities which would then, in turn also lower energy costs. This proved to be a big advance in fume hood airflows.

However, issues arose with sidewall sensing technology because these older airflow sensors in the 1980s tended to be unstable and cause continual actuation of standard airflow damper devices in response to changing airflows entering the fume hood. This phenomenon was often known as “hunting” as actuators responded to airflow sensors by continually “hunting” for a setpoint which never came as airflows continued to vary into a fume hood even if the sash did not move. The result was wasted energy and compromised safety. Moreover, existing blade damper devices tended to be inadequate in maintaining stable airflows into a fume hood which also threatened user safety while being generally energy inefficient. Of course, sash sensors also caused concern for laboratory facility managers due to the fact that they could not account for external events to a hood that affected airflows into the hood.

The result of all of the foregoing was the next major advance in energy savings in a laboratory safety occurred with the advent of variable air volume control systems in tandem with venturi valves proved to be one of the great advances in airflow control in laboratories to provide fast response, energy efficient airflow control. In U.S. Pat. No. 4,155,289, the invention eliminated all bypass concepts, employing and regulating instead, for maximum energy efficiency, only working throughput of the hood by utilizing venturi valves in each single unit laboratory hood as a calibrated flow device which automatically controls its own volume flow rate and automatically changes that volume flow rate as the hood inlet face area changes. Thus, this invention maintained a constant face-area inlet velocity and operated unaffected by pressure changes and fluctuations which were inherent characteristics of foregoing systems and air moving devices to which a hood is normally connected; and which maintained all of the above advantages even when multiple hoods were connected into a single exhaust system; As noted in the patent, energy savings were substantial including an estimated 900 kilowatt hours of electric power savings per hood per cooling season, and about 100 gallons of fuel oil per hood per heating season, by reducing the make-up air demand by the hood on heated and cooled air supply in the spaces in which they are located;

In this embodiment, venturi valves provided a constant flow of air into fume hoods to provide for the safety of its laboratory users. Typically, in most arrangements, a spring compensated cone tied to a cantilevered leg which is connected to either a sash sensing device or other flow control device. Then, as airflow changed, in sash or airflow systems where airflow devices are being used to sense airflow, they would adjust the levered arm of the venturi valve as they sensed airflow changes to modulate airflow accordingly to maintain a fixed constant volume of air into the fume hood regardless of what was happening outside of the fume hood. The usual targeted face velocity airflows into a fume hood were between 75-125FPM.

Additionally, the spring loaded cone, also adjusted to changes in duct static pressure such that if static pressure increased, the spring compressed and the cone tended to move into the venturi reducing the open area so the higher pressure and smaller opening combined to maintain a flow setpoint. Conversely, where static pressure decreased, less force was applied to the spring loaded cone which would cause the spring within the cone to expand pulling the cone away from the venturi. Thus, the combination of lower pressure and larger open area would combine to provide the desired airflow. Fume hood systems wasted fuel when they exhausted, up-the-chimney, heated or cooled room-ambient air used as purging throughput for the hood.

This phenomenon was described in U.S. Pat. No. 4,215,627 where as the sash was closed or opened, the cam rotation caused the cam follower to vary according to the axial position of the valve gate in the venturi throat, throttling the duct throughput air in an amount continuously proportional to the area of the access opening. Surges or other pressure changes were automatically compensated by the sliding movement of the valve gate on the valve stem.

Because the valve is a pressure independent valve, the self-contained feature of the spring-loaded cone or valve gate maintains the preset air flow automatically. A rise in pressure increases the force against the cone, flexing the spring so that the cone moves along the fixed shaft deeper into the valve throat. This reduces the valve free area just enough to maintain the preset flow at the higher pressure. A decrease in pressure permits the spring to move the cone out of the valve throat. The annular free area increases just enough to maintain the original flow at the lower pressure. The cone or valve gate thus serves to modify throttling of the throughput at the exhaust. It senses changes in throughput at the exhaust and compensates the changes in throughput sensed at the exhaust by sliding on the rod and varying the throughput-opening area at the venturi section of the duct. It will be noted that this compensation is by means independent of the throttling through setting of the linkage in predetermined relation to the area adjustment of the access opening by sash positioning.

While this device functions properly in many instances to maintain laboratory safety while conserving energy, there have been significant issues with the implementation of the valve for use in variable air volume, and/or more recently, two-state (occupied, unoccupied) applications. Two state systems involve occupancy sensors at the room, zone or individual fume hoods are used to increase exhaust air to a preset CFM when it detects the presence of an individual(s) for safety, and then to decrease exhaust air to a lower preset CFM when it detects the absence of users in a room, lab zone, or fume hood for a pre-programmed period of time.

These customer issues with existing venturi valve implementations include: one, a phenomenon known as “slamming” where the spring loaded cone will excessively oscillate for prolonged periods of time outside of any control loops or in response to any control signals from the controlling laboratory system. The repeated oscillation produces a shrill and bothersome “banging” sound as the out of control floating cone continually “bangs” against the inlet of the valve assembly¹. The usual causes for this phenomemon can be extreme changes in duct static pressure, improper design, improper construction, inadequate airflow in the system or excessive airflow in the system among other things, or other common airflow balancing issues. These issues, however, are not easily ascertained or resolved, and can often require much time and effort involving the mechanical contractor, controls contractor, design engineer, laboratory controls manufacturer, service personnel, end user and the air balancer. The often joint and coordinated effort to resolve these issues greatly adds to the cost of any installation besides being unsettling to the laboratory occupants. Moreover, there are other severe consequences of this phenomenon that have long term effects on the energy savings, safety and long term operational cost. These effects include severe damage to the valve assembly, a shortening in the length of the life of the valve over time, lost energy savings, and, most importantly, the compromise of user safety as the out of control venturi device prevents the system from maintaining balance thereby compromising safety to laboratory occupants.
¹In fairness to all manufacturers of venturi valves, and all control approaches to maintaining safe airflows in a laboratory, it should be noted that this phenomenon has been observed in virtually all contexts and with all manufacturers and control approaches. The description of this phenomenon is not intended, nor does it contemplate the targeting of a particular corporation or “brand” of venturi valve.

Secondly, another phenomenon that is observed with venturi valves within the context of laboratory airflow control systems is excessive hysterisis in the control response of the cone due to irregularities in the dimensions of the sliding disc inside the cone. Hysterisis refers to an inconsistent control response to similar change in airflow or similar responses with respect to the control stroke of an actuator. This phenomenon also has a number of different causes. These causes can include the build-up of substances on the shaft, rod or tube upon which the cone rides, excessive turbulence in the duct resulting from fluctuations in airflow, and the construction of the valve disc at the bottom of the cone. In its most extreme manifestation, which occurs with a fair amount of regularity in the field, this excessive hysterisis will cause the cone to “stick” or lock up in a fixed position so that it no longer responds properly to changes in airflow and/or to signals from the controlling system. A major cause of this phenomenon is caused by the thickness of the disc of the cone catching onto the seam welds of the shaft or cone among other factors.

These two issues have arisen in various job sites with multiple companies who use the valve for the control of airflow. They result in great consternation to the end user and other lab users of the lab due to the loud external noises caused by slamming valves or sticking valves and of course, compromise the integrity and safety of the system through their malfunctions.

The present invention resolves most of the externalities referenced above through the insertion of a piston ring utilized in conjunction with a modified disk in the cone so that “slamming” and “”sticking” are remedied. This is done through the insertion of an O-ring, in the disc at the bottom of the plunger cone of the valve to act in tandem with the modified cone. The simple yet ingenious effect of this ring and the modified cone is to resolve virtually all manifestations of the two issues referenced above. This invention resolves those issues by: dampening the oscillation effects of spring loaded cones in response to its movements along the shaft while providing for a consistent control response and consistent movements of the cone along the shaft while avoiding the “sticking” phenomenon referenced above.

To summarize, this invention includes a system for preventing the slamming and sticking venturi phenomena that has plagued various laboratory installations across the country through the insertion of an 0-ring to provide constant intake velocity in fume-hoods and consistent through hood exhaust throttling responsively through effective compensations for variations in access opening and ambient pressure seen in laboratories.

The above and other objects and advantages of the invention will become more readily apparent upon examination of the following description, including the drawings in which the reference numerals refer to the same reference parts in multiple drawings:

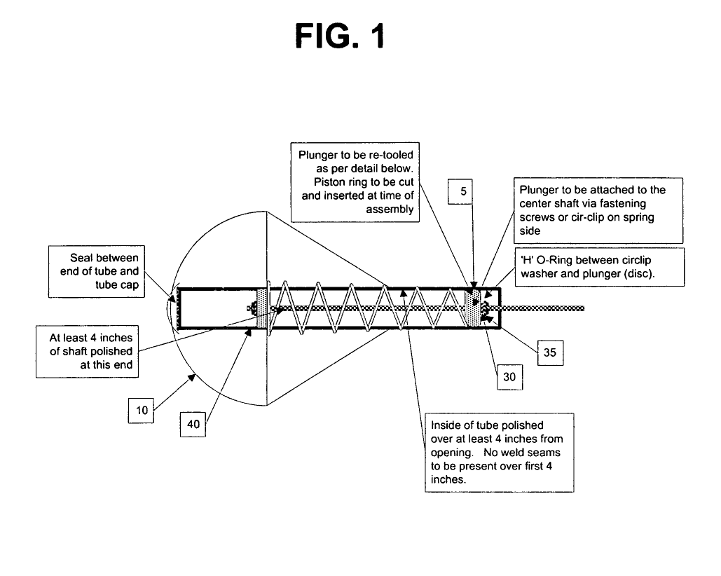

FIG. 1 is a two dimensional view of the structural modifications to the venturi valve

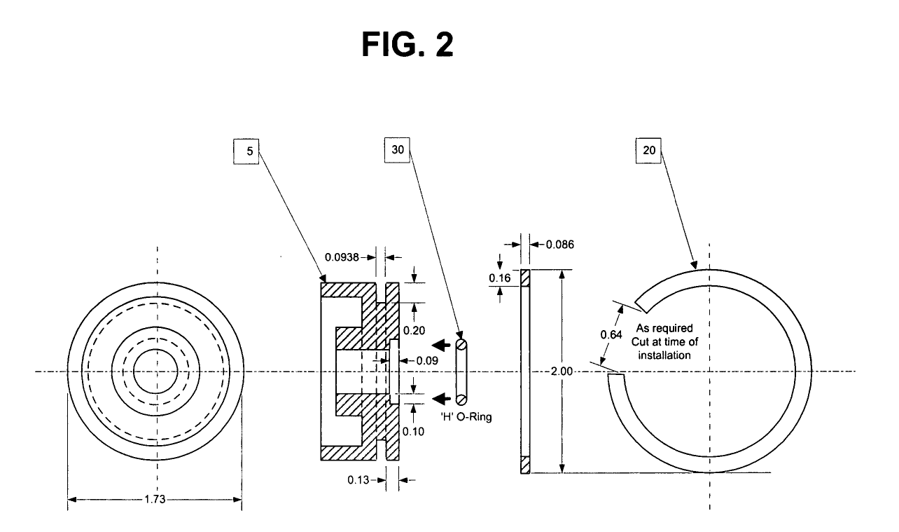

FIG. 2 is a detailed view of the modifications made to the plunger cone that rides along the shaft portion of the venturi valve.

### DETAILED DESCRIPTION OF A PREFERRED EMBODIMENT

FIG. 1 shows a “view through” schematic diagram of the modified and improved venturi valve. The Venturi valve depicted here, which is typical of the basic structure of venturi valves shows a disc 5 that operates as a spacer attached to the main shaft of the valve. The plunger cone 10 of the valve is also depicted as it slides along the shaft of the venturi valve to modulate the flow of air needed to ensure safe and/or energy efficient airflows based on the presence of occupants in the laboratory and change to airflow caused by external affects as seen in ASHRAE 14.12². The disc 5 is modified by cutting a slot or groove across its face that is slightly larger than the O-ring 20 that is inserted into its body. See, FIG. 2. The O-ring 20 is created out of Teflon in accordance with standard manufacturing procedures (though other suitable materials could also be utilized) and is then inserted into the groove of the disc 5 created by the cut.
² 2003 edition of ASHRAE Handbook lists factors that can affect airflow into a hood including operator movements in front of the hood, persons walking past the hood, open doors, open windows, pressure changes in the laboratory, et. Al.

The O-ring 30 is inserted between the circlip washer 35 and the plunger cone 10. The plunger cone 10 is attached to the center shaft via fastening screws or cir-clip on the spring side of the disc 5.

By inserting the O-ring 20 into the disc 5 the result is a functional piston ring that will modulate and dampen particularly excessive movements of the cone of the valve along the shaft in response to the factors previously described. The disc 5 and plunger cone 10 accomplish this effect by constricting the release of air out of the tube inside the cone, so that the cone movement is modulated and dampened in a way such that extreme oscillation of the plunger cone is obviated.

Additional modifications to the basic structure of the venturi valve are also noted on the drawing including the inclusion of a seal between the end of the tube 40 and the tube cap of the plunger cone.

This embodiment also discloses a further modification of the valve such that the top 4 inches of the top of the shaft are polished at the top of the cone and the bottom 4 inches of the inside of the tube 40 from the opening are also polished so that no weld seams are present over the bottom 4 inches of the tube.

FIG. 2 displays the plunger modifications made to the plunger cone and the ring from both a vertical top down and side view perspective, respectively. The plunger cone 10 with its disc 5 at the bottom is, as denoted by the diagram 1.73 inches in diameter as noted in the diagram.

In the sideview, a 0.0937 inch slot is cut around the circumference of the disc 5 to a depth of 0.20 inches. The bottom of the disk portion underneath the cut around the circumference of the disc is 0.13 inches as indicated on the diagram.

The ring 30 is manufactured to the following specifications to be inserted into the disc 5 to fulfill its function. Its diameter is 2.00 inches and the width of the ring part of it is 0.16 inches. Vertically, the height of the ring as indicated in the drawing is 0.0859 inches. The ring at this diameter acts to provide a slight springiness when compressed to the diameter of the disc. This in turn provides for the sealing of the disc/plunger in the tube.

The ring 30 is then inserted into the cut area of the disc 5 to function in tandem with the plunger cone as a car piston and ring as pressure changes occur in the duct to dampen the movement of the cone to avoid and buffer extreme oscillations caused by changes in duct static pressure and other factors to ensure a smoother operation of the valve in responding to airflow changes and promoting a longer lasting device with the dimensions of this embodiment. This improvement, the insertion of the “H” O-ring between the circlip washer and plunger disc, has the effect of creating a shock absorbing device that prevents excessive oscillation of the valve.

In conclusion it is again emphasized that with minimum elements, all proven, in inventive combination, a new and substantial self-operating means for energy saving in running costs is achieved safely, at modest fixed initial cost with simplicity and reliability. In the preferred vertical exhaust embodiment described it can be seen that the valve is failsafe in that if the stem linkage should fail the valve would remain in the open position.

The invention is not to be construed as limited to the particular forms disclosed herein, since these are to be regarded as illustrative rather than restrictive. It is, therefore, to be understood that the invention may be practiced within the scope of the claims otherwise than as specifically described.

1. A significant improvement to the existing venturi valve airflow device which is used to produce constant-velocity flow of varying-pressure airflow in a laboratory fume hood whose area opening can be adjusted by sash movement consisting of the following:
a. External valve assembly in shaped venturi form
b. Internal shaft connected to the external valve
c. Internal spring loaded plunger cone that slides along the shaft
d. Pivot arm connected to the internal shaft
e. Associated actuation device that adjusts the position of the shaft in response to a controlling device that senses airflow changes around the hood opening.
f. Insertion of a specially manufactured ring between the spring loaded plunger cone and a washer

2. The controlling system referenced in claim 1 such that the plunger cone is reconfigured so that a piston ring device can be cut and inserted at the time of the assembly of the valve.

3. The controlling system referenced in claim 2 such that the plunger cone includes a tube that is polished at least 4 inches from the opening with no weld seams present.

4. The controlling system referenced in claim 3 such that the shaft at the other end of the valve is also polished

5. The controlling system referenced in claim 4 such that the plunger is attached to the center shaft via fastening screws or cir-clip on the spring side.
